(19) United States
(12) Patent Application Publication
(10) Pub. No.: US 2026/0249337 A1
(43) Pub. Date: Aug. 27, 2026

(54) SHORT-FLOW ROLLING DEVICE AND METHOD FOR SEAMLESS PIPE

(71) Applicant: Changzhou Institute of Technology, Changzhou (CN)

(72) Inventors: Tingzhuang Han, Changzhou (CN); Chaojie Che, Changchun (CN); Zhibing Chu, Taiyuan (CN); Hun Guo, Changzhou (CN); Hong Gao, Changzhou (CN); Xia Cao, Changzhou (CN); Jianhui Bai, Changzhou (CN)

(21) Appl. No.: 19/213,982

(22) Filed: May 20, 2025

(30) Foreign Application Priority Data
Feb. 25, 2025 (CN) 202510209833.7

(51) Int. Cl. B21B 19/04; B21B 45/02

(52) U.S. Cl. CPC B21B 19/04; B21B 45/0209

(57) ABSTRACT

The present invention provides a short-flow rolling device and method for a seamless pipe. The device includes a rolling mill, a transport table and an inner and outer wall cooling unit. In the present invention, by arranging the inner and outer wall cooling unit, a seamless pipe is obtained after being rolled by the rolling mill, and when the rolled pipe enters the transport table and one end of the pipe is aligned with a spray ring, the transport table stops transporting the pipe to keep the pipe still. At this time, a motor I drives a rocker I to rotate, and a telescopic rod II coincides with an axis of the pipe; and telescopic rods I and the telescopic rod II extend synchronously, and spray heads I and spray heads II simultaneously cool an outer wall and an inner wall of the pipe.

### CROSS-REFERENCE TO RELATED APPLICATION

This application claims priority of Chinese Patent Application No. 202510209833.7, filed on Feb. 25, 2025, the entire contents of which are incorporated herein by reference.

### TECHNICAL FIELD

The present invention relates to the technical field of seamless pipe short-flow rolling, and in particular to a short-flow rolling device and method for a seamless pipe.

### BACKGROUND

Pipe rolling is a metal pressure working process specifically used to produce pipes; the pipes produced by pipe rolling are widely used in various fields, including oil well pipes and pipelines used to transport oil and gas in oil and gas industries, pipes for water supply and drainage, heating and gas supply in the construction industry and pipes for building structures; pipes and mechanical parts used in hydraulic system and pneumatic system in machinery manufacturing industry; fuel pipes, brake pipes and air conditioning pipes used in automobile manufacturing industry; and pipes used to transport various corrosive media in chemical industry.

Seamless pipes need to be cooled during rolling, and one of the common cooling methods is spray cooling. When spray cooling, the surface of the seamless pipe is in direct contact with the cooling water, and the cooling rate is relatively fast, while the internal heat transfer of the pipe is relatively slow, resulting in inconsistent cooling rate inside and outside the pipe, uneven cooling, and a temperature difference, which may cause the pipe to produce internal stress, affect the dimensional accuracy and shape of the pipe, and even lead to the deformation of the pipe in serious cases. In addition, the cooling depth is limited, and for thick-walled pipes, it is difficult to make the interior of the pipe meet the requirements of rapid cooling only by the existing spray cooling, which will cause a large difference in the internal and external properties of the pipe, and cannot meet some application scenarios with high requirements for the internal performance of the pipe.

In view of this, the present invention provides a short-flow rolling device and method for a seamless pipe to solve the above-described technical problems.

### SUMMARY

To make up for the deficiency of the related art, inner and outer walls of a seamless pipe on a transport table can be spray cooled together, and the present invention provides a short-flow rolling device and rolling method for a seamless pipe.

The technical solutions adopted by the present invention to solve the technical problem are as follows. A short-flow rolling device for a seamless pipe includes a rolling mill, a transport table and an inner and outer wall cooling unit; the rolling mill is capable of short-flow rolling of the seamless pipe; the rolled seamless pipe subsequently enters the transport table, which can transport the seamless pipe; and the inner and outer wall cooling unit is capable of spraying and cooling outer walls of the seamless pipe on the transport table together.

The seamless pipe needs to be cooled during rolling, and one of the common cooling methods is spray cooling. When spray cooling, a surface of the seamless pipe is in direct contact with the cooling water, and the cooling rate is relatively fast, while the internal heat transfer of the pipe is relatively slow, resulting in inconsistent cooling rate inside and outside the pipe, uneven cooling, and a temperature difference, which may cause the pipe to produce internal stress, affect the dimensional accuracy and shape of the pipe, and even lead to the deformation of the pipe in serious cases. In addition, the cooling depth is limited, and for thick-walled pipes, it is difficult to make the interior of the pipe meet the requirements of rapid cooling only by the existing spray cooling, which will cause a large difference in the internal and external properties of the pipe, and cannot meet some application scenarios with high requirements for the internal performance of the pipe. Therefore, the rolled seamless pipe subsequently is entered the transport table, and the inner and outer wall cooling unit is capable of spraying and cooling outer walls of the seamless pipe on the transport table together, and the inner and outer walls of the pipe are cooled relatively uniformly.

Preferably, the inner and outer wall cooling unit includes fixing seats, two sides of one end of the transport table being fixedly connected to the fixing seats, and each of the fixing seats being fixedly connected to a telescopic rod I, and the telescopic rods I being positioned on two sides of the transport table; and the other ends of the two telescopic rods I being jointly fixedly connected to a spray ring, the rolled seamless pipe being capable of passing through the spray ring, a plurality of spray heads I being evenly arranged on an inner side of the spray ring, and the spray ring being externally connected to a water pipe and communicated with an interior of the spray ring; and a motor I, the motor I being fixedly connected to one side of one end of the fixing seat positioned at the transport table, an output shaft of the motor I being fixedly connected to a rocker I, one side of the rocker I being fixedly connected to a telescopic rod II, the other end of the telescopic rod II being fixedly connected to a block I, the block I being capable of entering an interior of the seamless pipe, a plurality of spray heads II being arranged around the block I, and the block I being externally connected to the water pipe and communicated with an interior of the block I.

Preferably, a limited block is fixedly connected to one of the fixing seats and located at a position of the motor I.

When the rolled pipe enters the transport table, when the telescopic rods I are retracted to the shortest, the spray ring is located in a middle of the transport table, at this time, when one end of the pipe is aligned with a position of the spray ring, the transport table stops the transportation of the pipe, and the pipe is kept still; the motor I drives the rocker I to rotate, the rocker I is in contact with the limited block, and at this time, the telescopic rod II happens to coincide with an axis of the pipe; the telescopic rods I and the telescopic rod II are synchronously elongated, and the spray heads I and the spray heads II cool the outer wall and the inner wall of the pipe at the same time; the telescopic rods I and the telescopic rod II are controlled to reciprocate to cool the pipe to an appropriate temperature; after cooling, the telescopic rods I and the telescopic rod II are retracted to the shortest; and the motor I drives the rocker I to rotate, the telescopic rod II moves to a side of the transport table, as shown in FIG. 4, without affecting the subsequent transport of the pipe, and the transport table continues to transport the pipe and carry out subsequent processes.

Preferably, a ring I is rotatably connected to a central part of the spray ring, a cross-sectional shape of the ring I is a semi-enclosing shape, an interior of the ring I communicates with an interior of one side of the spray ring, and the spray heads I are fixedly connected to an inner wall of the ring I and communicates with the interior of the ring I.

Preferably, one side of an inner wall of the spray ring is fixedly connected to a transmission box, a side wall of the ring I is fixedly connected to a face gear, and a shaft I and a shaft II are rotatably connected to an interior of the transmission box; and the shaft I is fixedly connected to a contact wheel and a bevel gear I, the shaft II is fixedly connected to a gear I and a bevel gear II, the bevel gear I is meshed with the bevel gear II, the gear I is meshed with the face gear, the contact wheel is in pressing contact with a side wall of the transport table, and the gear I is capable of driving the ring I to rotate.

The spray ring is rotatably connected to the ring I, the water in the spray ring can enter the ring I and be sprayed out through the spray heads I, a rotating connection will not leak, and the water will not enter the face gear. The telescopic rods I are stretched and retracted to drive the spray ring to perform reciprocating motion on the outer wall of the pipe, the contact wheel contacts a side wall of the transport table, and rotates; and at this time, through the transmission of the bevel gear I, the bevel gear II and the gear I, the face gear rotates with the ring I, and the ring I rotates to drive the spray heads I to rotate around the pipe and spray water, thereby reducing spraying dead corners and enabling more sufficient and uniform cooling.

Preferably, the spray heads I include pipes I and pipes II, the pipes II are nested inside the pipes I, electromagnets I are fixedly connected to inner end parts of the pipes I, fixing rings I are fixedly connected to ends of the pipes II, springs I are fixedly connected between the fixing rings I and the electromagnets I, and the fixing rings I are attracted when the electromagnets I are electrified.

Preferably, the spray heads II are slidably connected to an interior of the block I, end parts of the spray heads II are fixedly connected to fixing rings II, the interior of the block I and corresponding to a position of each spray head II is fixedly connected to an electromagnet II, and springs II are fixedly connected between the fixing rings II and the corresponding electromagnets II; and the electromagnets II be capable of attracting the corresponding fixing rings II when being electrified, and each of the spray pipes II is communicated with the interior of the block I.

When the electromagnets I are energized, the fixing rings I are attracted, the pipes II stretch out from the interior of the pipe I, on the contrary, the pipes II are retracted into the pipes I, changing a distance between a water injection nozzle and the outer wall of the pipe. Because a water spray distance also has an impact on the cooling effect, the setting meets the needs of different pipe thicknesses and different degrees of cooling. In the same way, when the electromagnets II are energized, the corresponding fixing rings II can be attracted, the spray heads II extend out of the block I, and retract the block I on the contrary, thereby adapting to the inner diameter with different pipes.

A short-flow rolling method for a seamless pipe by adopting the short-flow rolling device for a seamless pipe described above includes the following steps:
S1: obtaining a seamless pipe after being rolled by a rolling mill, stopping transporting the pipe to keep the pipe still by a transport table when the rolled pipe enters the transport table and one end of the pipe is aligned with a spray ring; while driving a rocker I to rotate by a motor I to cause a telescopic rod II to be coincided with an axis of the pipe; and at this time, extending telescopic rods I and the telescopic rod II synchronously, and cooling an outer wall and an inner wall of the pipe by spray heads I and spray heads II;
S2: stretching and retracting the telescopic rods I to drive the spray ring to perform reciprocating motion on the outer wall of the pipe, with a contact wheel contacting and rotating against a side wall of the transport table, driving a ring I to rotate by a face gear through the transmission of a bevel gear I, a bevel gear II and a gear I, and driving spray heads I to rotate around the pipe by rotating the ring I for rotating water spraying, reducing spraying dead corners and enabling more sufficient and uniform cooling; and
S3: retracting the telescopic rods I and the telescopic rod II to the shortest length after the cooling is completed, driving the rocker I to rotate by the motor I, moving the telescopic rod II to a side of the transport table without affecting the subsequent transportation of the pipe, and transporting the pipe continuously by the transport table, and carrying out the subsequent processes.

The present invention has the following advantageous effects.
1. According to the short-flow rolling device and method for a seamless pipe provided by the present invention, by arranging the inner and outer wall cooling unit, the seamless pipe is obtained after being rolled by the rolling mill. When the rolled pipe enters the transport table and one end of the pipe is aligned with the spray ring, the transport table stops transporting the pipe to keep the pipe still. At this time, the motor I drives the rocker I to rotate, and the telescopic rod II coincides with the axis of the pipe. At this time, the telescopic rods I and the telescopic rod II extend synchronously, and the spray heads I and the spray heads II simultaneously cool the outer wall and the inner wall of the pipe.
2. According to the short-flow rolling device and method for a seamless pipe provided by the present invention, the spray ring is driven to perform reciprocating motion on the outer wall of the pipe when the telescopic rods I stretch and retract, the contact wheel contacts and rotates against the side wall of the transport table; and at the same time, the ring I is driven to rotate by the face gear through the transmission of the bevel gear I, the bevel gear II and the gear I, and the spray heads I are driven to rotate around the pipe by rotating the ring I for rotating water spraying, reducing spraying dead corners and enabling more sufficient and uniform cooling.

### BRIEF DESCRIPTION OF THE DRAWINGS

The present invention will be further described below with reference to the accompanying drawings.

FIG. 1 is a perspective view I of the present invention;

FIG. 2 is a perspective view II of the present invention;

FIG. 3 is a partial enlarged view at A of FIG. 2;

FIG. 4 is a perspective view III of the present invention;

FIG. 5 is a partial perspective view of the present invention;

FIG. 6 is a cross-sectional view of a spray ring at a transmission box of the present invention;

FIG. 7 is a cross-sectional view of a spray pipe I of the present invention;

FIG. 8 is a cross-sectional view of a block I of the present invention;

FIG. 9 is a schematic diagram of a connection between a spray ring and a ring I of the present invention;

FIG. 10 is a schematic diagram of a rolling mill according to Example 2 of the present invention; and

FIG. 11 is a schematic diagram of rolls with different passes of the present invention.

Reference numerals and denotations thereof: 1—transport table; 2—inner and outer wall cooling unit; 21—fixing seat; 22—telescopic rod I; 23—spray ring; 24—spray head I; 25—motor I; 26—rocker I; 27—telescopic rod II; 28—block I; 29—spray head II; 3—limited block; 4—ring I; 5—transmission box; 51—face gear; 52—shaft I; 53—shaft II; 54—contact wheel; 55—bevel gear I; 56—gear I; 57—bevel gear II; 6—pipe I; 61—pipe II; 62—electromagnet I; 63—fixing ring I; 64—spring I; 7—fixing ring II; 71—electromagnet II; 72—spring II; 8—conveying roller table; 81—rotary feeding device; 82—rolling mill stand; 83—roll; 84—heat treatment box; 85—first connecting rod; and 86—second connecting rod.

### DETAILED DESCRIPTION

To easily understand the technical means, creative features, objectives and effects of the present invention, the present invention will be further elaborated with specific embodiments.

### EXAMPLE 1

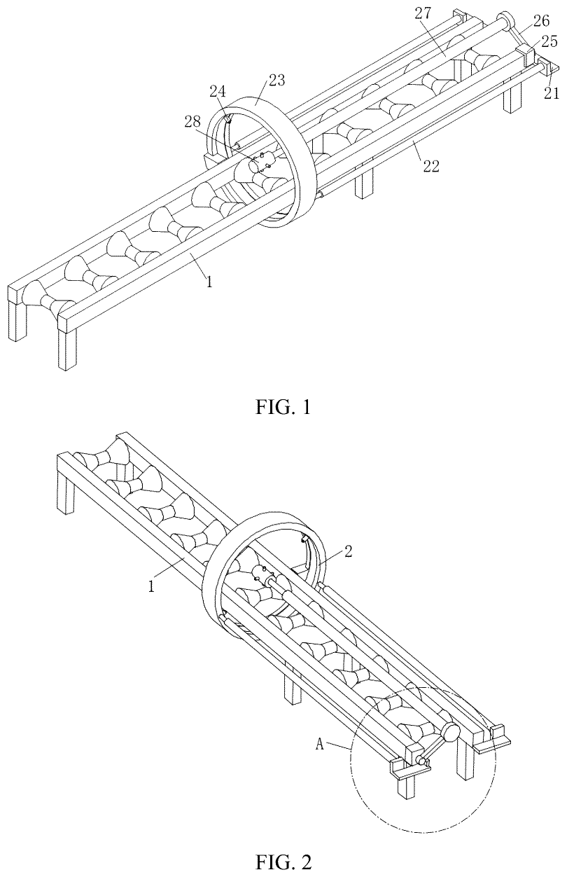

As shown in FIGS. 1 and 2:
the present invention provides a short-flow rolling device for a seamless pipe, including a rolling mill, a transport table 1 and an inner and outer wall cooling unit 2; the rolling mill is capable of short-flow rolling of a seamless pipe; the rolled seamless pipe is subsequently entered the transport table 1, which can transport the seamless pipe; and the inner and outer wall cooling unit 2 is capable of spraying and cooling outer walls of the seamless pipe on the transport table 1 together.

During the working period, the seamless pipe needs to be cooled during rolling, and one of the common cooling methods is spray cooling. When spray cooling, a surface of the seamless pipe is in direct contact with the cooling water, and the cooling rate is relatively fast, while the internal heat transfer of the pipe is relatively slow, resulting in inconsistent cooling rate inside and outside the pipe, uneven cooling, and a temperature difference, which may cause the pipe to produce internal stress, affect the dimensional accuracy and shape of the pipe, and even lead to the deformation of the pipe in serious cases. In addition, the cooling depth is limited, and for thick-walled pipes, it is difficult to make the interior of the pipe meet the requirements of rapid cooling only by the existing spray cooling, which will cause a large difference in the internal and external properties of the pipe, and cannot meet some application scenarios with high requirements for the internal performance of the pipe. Therefore, the rolled seamless pipe subsequently enters the transport table 1, and the inner and outer wall cooling unit 2 is capable of spraying and cooling outer walls of the seamless pipe on the transport table 1 together, and the inner and outer walls of the pipe are cooled relatively uniformly.

As shown in FIGS. 1, 2 and 5, the inner and outer wall cooling unit 2 includes fixing seats 21, two sides of one end of the transport table 1 being fixedly connected to the fixing seats 21, and each of the fixing seats 21 being fixedly connected to a telescopic rod I 22, and the telescopic rods I 22 being positioned on two sides of the transport table 1; and the other ends of the two telescopic rods I 22 being jointly fixedly connected to a spray ring 23, the rolled seamless pipe being capable of passing through the spray ring 23, a plurality of spray heads I 24 being evenly arranged on an inner side of the spray ring 23, and the spray ring 23 being externally connected to a water pipe and communicated with an interior of the spray ring 23; and a motor I 25, the motor I 25 being fixedly connected to one side of one end of the fixing seat 21 positioned at the transport table 1, an output shaft of the motor I 25 being fixedly connected to a rocker I 26, one side of the rocker I 26 being fixedly connected to a telescopic rod II 27, the other end of the telescopic rod II 27 being fixedly connected to a block I 28, the block I 28 being capable of entering an interior of the seamless pipe, a plurality of spray heads II 29 being arranged around the block I 28, and the block I 28 being externally connected to the water pipe and communicated with an interior of the block I 28.

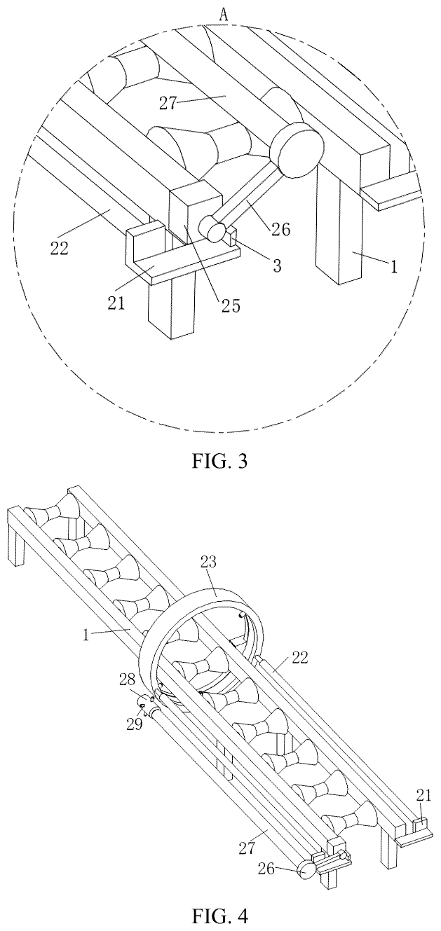

As shown in FIG. 3, a limited block 3 is fixedly connected to one of the fixing seats 21 and located at a position of the motor I 25.

During the working period, when the rolled pipe enters the transport table 1 and the telescopic rods I 22 retract to the shortest, the spray ring 23 is located in a middle of the transport table 1, at this time, when one end of the pipe is aligned with a position of the spray ring 23, the transport table 1 stops the transportation of the pipe, and the pipe is kept still; the motor I 25 drives the rocker I 26 to rotate, the rocker I 26 is in contact with the limited block 3, and at this time, the telescopic rod II 27 happens to coincide with an axis of the pipe; the telescopic rods I 22 and the telescopic rod II 27 are synchronously elongated, and the spray heads I 24 and the spray heads II 29 cool the outer wall and the inner wall of the pipe at the same time; the telescopic rods I 22 and the telescopic rod II 27 are controlled to reciprocate to cool the pipe to an appropriate temperature; after cooling, the telescopic rods I 22 and the telescopic rod II 27 are retracted to the shortest; and the motor I 25 drives the rocker I 26 to rotate, the telescopic rod II 27 moves to a side of the transport table 1, as shown in FIG. 4, without affecting the subsequent transport of the pipe, and the transport table 1 continues to transport the pipe and carry out subsequent processes.

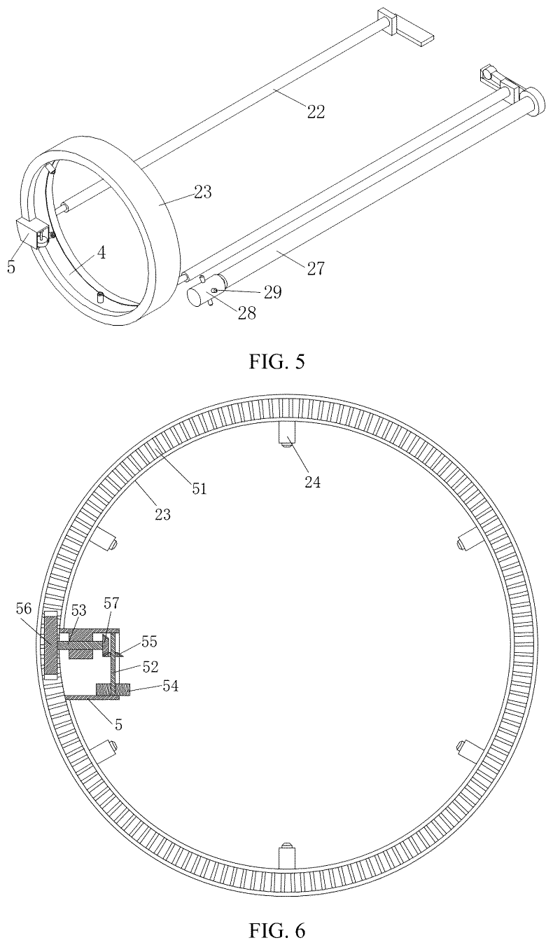

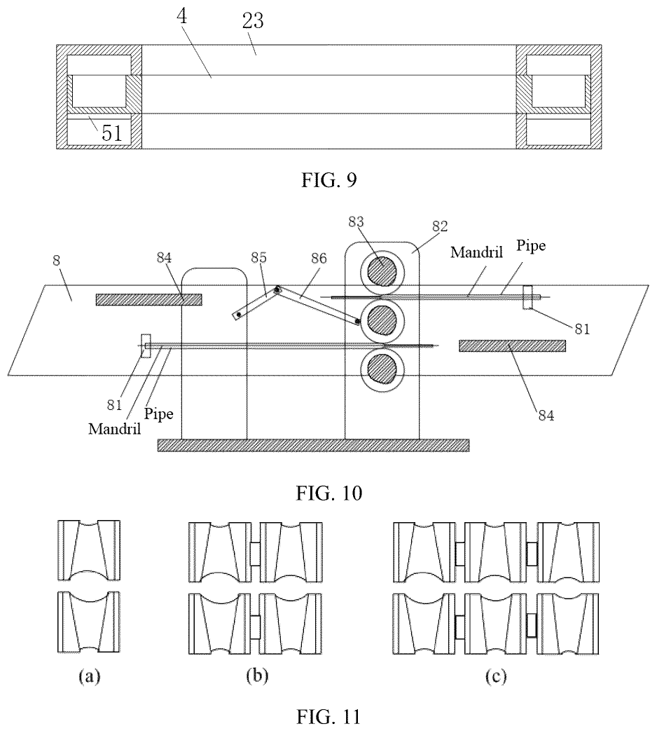

As shown in FIGS. 5 and 9, a ring I 4 is rotatably connected to a central part of the spray ring 23, a cross-sectional shape of the ring I 4 is a semi-enclosing shape, an interior of the ring I 4 communicates with an interior of one side of the spray ring 23, and the spray heads I 24 are fixedly connected to an inner wall of the ring I 4 and communicates with the interior of the ring I 4.

As shown in FIGS. 1 and 6, one side of an inner wall of the spray ring 23 is fixedly connected to a transmission box 5, a side wall of the ring I 4 is fixedly connected to a face gear 51, and a shaft I 52 and a shaft II 53 are rotatably connected to an interior of the transmission box 5; and the shaft I 52 is fixedly connected to a contact wheel 54 and a bevel gear I 55, the shaft II 53 is fixedly connected to a gear I 56 and a bevel gear II 57, the bevel gear I 55 is meshed with the bevel gear II 57, the gear I 56 is meshed with the face gear 51, the contact wheel 54 is in pressing contact with a side wall of the transport table 1, and the gear I 56 is capable of driving the ring I 4 to rotate.

During the working period, the spray ring 23 is rotatably connected to the ring I 4, the water in the spray ring 23 can enter the ring I 4 and be sprayed out through the spray heads I 24, a rotating connection will not leak, and the water will not enter the face gear 51. The telescopic rods I 22 are stretched and retracted to drive the spray ring 23 to perform reciprocating motion on the outer wall of the pipe, the contact wheel 54 contacts a side wall of the transport table 1, and rotates; and at this time, through the transmission of the bevel gear I 55, the bevel gear II 57 and the gear I 56, the face gear 51 rotates with the ring I 4, and the ring I 4 rotates to drive the spray heads I 24 to rotate around the pipe and spray water, thereby reducing spraying dead corners and enabling more sufficient and uniform cooling.

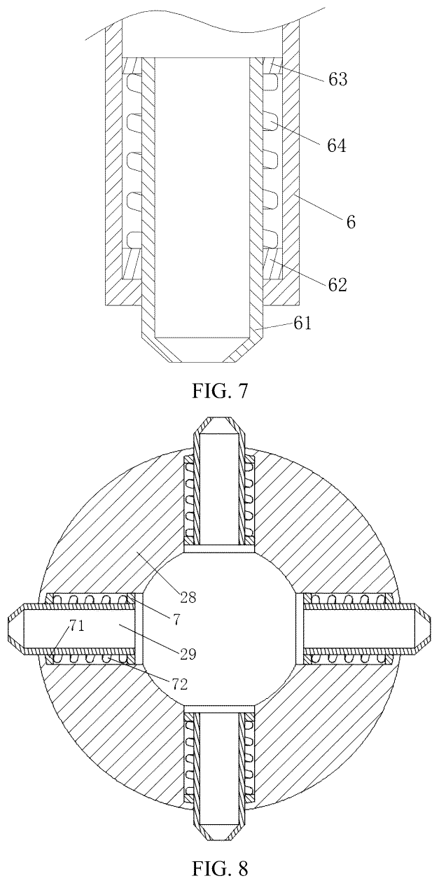

As shown in FIG. 7, the spray heads I 24 include pipes I 6 and pipes II 61, the pipes II 61 are nested inside the pipes I 6, electromagnets I 62 are fixedly connected to inner end parts of the pipes I 6, fixing rings I 63 are fixedly connected to ends of the pipes II 61, springs I 64 are fixedly connected between the fixing rings I 63 and the electromagnets I 62, and the fixing rings I 63 are attracted when the electromagnets I 62 are electrified.

As shown in FIG. 8, the spray heads II 29 are slidably connected to an interior of the block I 28, end parts of the spray heads II 29 are fixedly connected to fixing rings II 7, the interior of the block I 28 and corresponding to a position of each spray head II 29 is fixedly connected to an electromagnet II 71, and springs II 72 are fixedly connected between the fixing rings II 7 and the corresponding electromagnets II 71; and the electromagnets II 71 be capable of attracting the corresponding fixing rings II 7 when being electrified, and each of the spray pipes II is communicated with the interior of the block I 28.

During the working period, when the electromagnets I 62 are energized, the fixing rings 63 I are attracted, the pipes II 61 stretch out from the interior of the pipe I 6, on the contrary, the pipes II 61 are retracted into the pipes I 6, changing a distance between a water injection nozzle and the outer wall of the pipe. Because a water spray distance also has an impact on the cooling effect, the setting meets the needs of different pipe thicknesses and different degrees of cooling. In the same way, when the electromagnets II 71 are energized, the corresponding fixing rings II 7 can be attracted, the spray heads II 29 extend out of the block I 28, and retract the block I 28 on the contrary, thereby adapting to the inner diameter with different pipes.

A short-flow rolling method for a seamless pipe by adopting the short-flow rolling device for a seamless pipe described above includes the following steps:

In S1, the seamless pipe is obtained after being rolling by the rolling mill, and when the rolled pipe enters the transport table 1 and one end of the pipe is aligned with the spray ring 23, the transport table 1 stops transporting the pipe to keep the pipe still. At this time, the motor I 25 drives the rocker I 26 to rotate, and the telescopic rod II 27 coincides with the axis of the pipe. At this time, the telescopic rods I 22 and the telescopic rod II 27 extend synchronously, and the spray heads I 24 and the spray heads II 29 simultaneously cool the outer wall and the inner wall of the pipe.

In S2, the telescopic rods I 22 stretch and retract to drive the spray ring 23 to perform reciprocating motion on the outer wall of the pipe, and the contact wheel 54 contacts and rotates against a side wall of the transport table 1; and at this time, through the transmission of the bevel gear I 55, the bevel gear II 57 and the gear I 56, the face gear 51 rotates with the ring I 4, and the ring I 4 rotates to drive the spray heads I 24 to rotate around the pipe and spray water, thereby reducing spraying dead corners and enabling more sufficient and uniform cooling.

In S3, after cooling, the telescopic rods I 22 and the telescopic rod II 27 retract to the shortest, the motor I 25 drives the rocker I 26 to rotate, the telescopic rod II 27 moves to a side of the transport table 1, without affecting the subsequent transport of the pipe, and the transport table 1 continues to transport the pipe and carry out subsequent processes.

### EXAMPLE 2

The difference between Example 2 and Example 1 is that the rolling mill is different, and the rolling mill in Example 1 is an ordinary rolling mill. The rolling mill in Example 2 includes:
a conveying roller table 8, two ends of the conveying roller table 8 being mounted with rotary feeding devices 81, and a rolling mill stand 82 being fixedly mounted at the conveying roller table 8; and
rolls 83, three rolls 83 with the same pass being mounted at the rolling mill stand 82, and the three rolls 83 being arranged from top to bottom; a center of the rotary feeding device 81 on a left side being on the same horizontal line as a center of a pass of a lower roller 83, and a center of the rotary feeding device 81 on a right side being on the same horizontal line as a center of a pass of an upper roller 83; and heat treatment boxes 84 being mounted on conveying tracks on two sides of the rolling mill stand 82, a first connecting rod 85 being mounted on a box body of the heat treatment box 84, the first connecting rod 85 being connected to a second connecting rod 86, the first connecting rod 85 and the second connecting rod 86 being capable of driving the rolling mill stand 82 to reciprocate, which may be achieved by an electric push rod, and the first roller 83 at the top and the third roller 83 at the bottom having a difference of 180° in initial biting positions of the passes. As shown in FIG. 10, one pipe may be rolled in each of the upper and lower rollers 83.

In this example, a rolling process of the rolling mill is divided into two stages, a rolling stage of forward movement and a no-load return stage. As shown in FIG. 10, one pipe is rolled in each of the upper and lower rollers 83, the roller 83 at the top is in a no-load stage when the middle roller 83 and the lower roller 83 are combined to roll the pipe, the pipe can be rotated and fed, when the lower roller 83 is rolled, the pass of the upper roller 83 and the pass of the middle roller 83 start to cooperate, the pipe bites and rolls, the lower roller 83 is no-load, and the lower pipe can be rotated and fed. In this way, the whole rolling mill is working when running, there is no no-load process, the middle roller 83 is always kept in the rolling state, and the upper and lower pipes can be rolled once in the front and rear movement process of the rolling mill stand 82, improving the utilization rate of the pass, improving the rolling efficiency and reducing the energy consumption.

In addition, the heat treatment boxes 84 (room temperature to 1000° C.) are mounted on the conveying roller table 8 on two sides of the rolling mill stand 82, and the pipe can enter the heat treatment box 84 after exiting the roller 83, and the heat treatment process such as annealing can be completed online, saving time and space for subsequent rolling, and improving efficiency.

As shown in FIG. 11, the rollers 83 can also have a single pass, two passes and three passes (the outer diameter of 2-20 mm can be rolled according to the needs, and the passes can be freely combined and configured), and the rolling of pipes of various sizes can be realized on one rolling mill. In combination with the heat treatment boxes 84, it is possible to realize multi-pass rolling or even one-pass forming on one rolling mill, for example, the lower roller 83 is rolled once with the largest pass and heat-treated in line and can be moved to the upper roller 83 for a second rolling with the middle pass and heat-treated, and moved to the lower roller 83 for a third rolling and heat treatment with the smallest pass, thereby realizing multi-size rolling on one rolling mill and one-pass forming of the pipe. In addition, the three passes can also be used alternately, the largest pass can be used for the lower roller 83, and the middle pass or the smallest pass can be used for the upper roller 83, which means that the reciprocating movement of the rolling mill stand 82 can roll pipes of different sizes.

The rolling mill in this example has the following usage methods.
Method 1: two stainless steel pipes with an outer diameter of 8 mm and a wall thickness of 1.5 mm, mandrels are inserted into the pipes and fixed to the rotary feeding devices 81 on the left and right sides, the left pipe is rolled by the lower roller 83 and the middle roller 83, the right pipe is rolled by the upper roller 83 and the middle roller 83, and the two pipes move relatively; the lower roller 83 bites into the pipe first, as the rolling mill stand 82 moves forward, the rollers 83 rotate and roll, the rolling mill stand 82 runs to the far right side, the lower roller 83 and the middle roller 83 rotate 180°, at this time, the upper roller 83 and the middle roller 83 can just bite into the right side pipe for rolling, the right side pipe is rolled in the return process, and the left side pipe is unloaded and rotated and fed. The rolling mill stand 82 returns to the initial position, the right pipe is rolled, the upper roller 83 and the middle roller 83 rotate 180° to return to the initial position, the pass of the middle roller 83 cooperates with the pass of the lower roller 83 to roll the left pipe, during which the upper roller 83 also rotates with no load, the right pipe rotates and feeds, the two stainless steel pipes are rolled at the same time in the same rolling mill stand 82, and the upper and lower rollers 83 work alternately until the pipes are rolled, with an outer diameter of 7 mm and a wall thickness of 1.2 mm. This method can roll two pipes at the same time, without increasing the floor area, and at the same time, the upper and lower rolls 83 work alternately. There is no no-load stage in the whole movement process of the rolling mill stand 82, and the efficiency is improved. The rolling mill stand 82 is always kept in the same rolling force range, and there is no obvious impact and vibration in the rolling process.
Method 2: two stainless steel pipes with an outer diameter of 8 mm and a wall thickness of 1.5 mm, mandrels are inserted into the pipes and fixed to the rotary feeding devices 81 on the left and right sides, the left pipe is rolled by the lower roller 83 and the middle roller 83, the right pipe is rolled by the upper roller 83 and the middle roller 83, and the two pipes move relatively; the lower roller 83 bites into the pipe first, as the rolling mill stand 82 moves forward, the rollers 83 rotate and roll, the rolling mill stand 82 runs to the far right side, the lower roller 83 and the middle roller 83 rotate 180°, at this time, the upper roller 83 and the middle roller 83 can just bite into the right side pipe for rolling, the right side pipe is rolled in the return process, the left side pipe is unloaded and rotated and fed, and the front ends of the pipes have entered the heat treatment boxes 84 to start heat treatment. The rolling mill stand 82 returns to the initial position, the right pipe is rolled, the upper roller 83 and the middle roller 83 rotate 180° to return to the initial position, the pass of the middle roller 83 cooperates with the pass of the lower roller 83 to roll the left pipe, during which the upper roller 83 also rotates with no load, and the right pipe rotates and feeds. The front ends of the pipes enter the heat treatment boxes 84 to start the heat treatment, the upper and lower rollers 83 work alternately, the back ends of the pipes are rolled, and the front ends of the pipes are heat treated, step by step until the pipe rolling is completed, with an outer diameter of 7 mm and a wall thickness of 1.2 mm. The pipes can directly enter the next rolling mill for smaller size rolling until the target size is reached with an outer diameter of 4 mm and a wall thickness of 0.5 mm.
Method 3: two stainless steel pipes with an outer diameter of 8 mm and a wall thickness of 1.5 mm, and mandrels are inserted into the pipes and fixed to the rotary feeding devices 81 on the left and right sides. Rollers 83 in the rolling mill are disposed with three different sizes of passes, the left pipe is rolled by the lower roller 83 with the maximum pass and the middle roller 83, the lower roller 83 bites into the pipe first, moves forward with the rolling mill stand 82, the rollers 83 rotate and roll, the rolling mill stand 82 runs to the far right, the lower roller 83 rotates 180° with the middle roller 83, the left pipe is unloaded, and rotated and fed. The front ends of the pipes have entered the heat treatment boxes 84 to start heat treatment; the rolling mill stand 82 is returned to the initial position, the pass of the middle roller 83 is matched with the pass of the lower roller 83 to roll the left pipe, and during which the upper roller 83 rotates with no load and gradually progresses until the lower pipe is rolled, with an outer diameter of 6.6 mm and a wall thickness of 1.1 mm. This pipe is moved to the upper end, rolled by the middle pass of the upper roller 83, the front end of the rolled pipe directly enters the heat treatment box 84 for heat treatment, and the rear end is continuously rolled, with an outer diameter of 5.4 mm and a wall thickness of 0.8 mm. At the same time, the maximum pass of the lower roller 83 and the middle roller 83 continue to cooperate with rolling, and the rolling process is the same as above. After the rolling of the two pipes is completed, the original upper pipe is moved to the minimum hole diameter of the lower roller 83 for rolling and heat treatment, the second pipe rolled by the lower roller 83 is moved to the middle pass of the upper roller 83 for rolling and heat treatment, and the rolling process is the same as above. The lower roller 83 obtains the final pipe target size outer diameter of 4 mm and wall thickness of 0.5 mm. In this way, one-time forming can be realized on one rolling mill, and continuous rolling of pipes of different sizes can be realized.

In addition, according to different product needs, different materials (copper pipe, aluminum alloy pipe, magnesium alloy pipe, etc.) can be selected with different rolling processes, rollers 83 with different passes rolling, and different heat treatment processes, etc.

The above examples are only used to illustrate the technical solutions of the present invention and not to limit it. Although the present invention has been described in detail with reference to the above-described examples, those skilled in the art will understand that modifications or equivalent substitutions can still be made to the specific embodiments of the present invention, and any modifications or equivalent substitutions that do not depart from the spirit and scope of the present invention are to be covered within the scope of the claims of the present invention.

1. A short-flow rolling device for a seamless pipe, comprising:
a rolling mill, the rolling mill being capable of short-flow rolling of a seamless pipe; and
a transport table (1), the rolled seamless pipe entering the transport table (1), and the transport table (1) being capable of transporting the seamless pipe, and
the short-flow rolling device for a seamless pipe further comprising:
an inner and outer wall cooling unit (2), the inner and outer wall cooling unit (2) being capable of spraying and cooling inner and outer walls of the seamless pipe on the transport table (1) together.

2. The short-flow rolling device for a seamless pipe according to claim 1, wherein the inner and outer wall cooling unit (2) comprises:
fixing seats (21), two sides of one end of the transport table (1) being fixedly connected to the fixing seats (21), each of the fixing seats (21) being fixedly connected to a telescopic rod I (22), and the telescopic rods I (22) being positioned on two sides of the transport table (1); and the other ends of the two telescopic rods I (22) being jointly fixedly connected to a spray ring (23), the rolled seamless pipe being capable of passing through the spray ring (23), a plurality of spray heads I (24) being evenly arranged on an inner side of the spray ring (23), and the spray ring (23) being externally connected to a water pipe and communicated with an interior of the spray ring (23); and
a motor I (25), the motor I (25) being fixedly connected to one side of one end of the fixing seat (21) positioned at the transport table (1), an output shaft of the motor I (25) being fixedly connected to a rocker I (26), one side of the rocker I (26) being fixedly connected to a telescopic rod II (27), the other end of the telescopic rod II (27) being fixedly connected to a block I (28), the block I (28) being capable of entering an interior of the seamless pipe, a plurality of spray heads II (29) being arranged around the block I (28), and the block I (28) being externally connected to the water pipe and communicated with an interior of the block I (28).

3. The short-flow rolling device for a seamless pipe according to claim 2, wherein a limited block (3) is fixedly connected to one of the fixing seats (21) and located at a position of the motor I (25).

4. The short-flow rolling device for a seamless pipe according to claim 3, wherein a ring I (4) is rotatably connected to a central part of the spray ring (23), a cross-sectional shape of the ring I (4) is a semi-enclosing shape, an interior of the ring I (4) communicates with an interior of one side of the spray ring (23), and the spray heads I (24) are fixedly connected to an inner wall of the ring I (4) and communicates with the interior of the ring I (4).

5. The short-flow rolling device for a seamless pipe according to claim 4, wherein one side of an inner wall of the spray ring (23) is fixedly connected to a transmission box (5), a side wall of the ring I (4) is fixedly connected to a face gear (51), and a shaft I (52) and a shaft II (53) are rotatably connected to an interior of the transmission box (5); and the shaft I (52) is fixedly connected to a contact wheel (54) and a bevel gear I (55), the shaft II (53) is fixedly connected to a gear I (56) and a bevel gear II (57), the bevel gear I (55) is meshed with the bevel gear II (57), the gear I (56) is meshed with the face gear (51), the contact wheel (54) is in pressing contact with a side wall of the transport table (1), and the gear I (56) is capable of driving the ring I (4) to rotate.

6. The short-flow rolling device for a seamless pipe according to claim 5, wherein the spray heads I (24) comprise pipes I (6) and pipes II (61), the pipes II (61) are nested inside the pipes I (6), electromagnets I (62) are fixedly connected to inner end parts of the pipes I (6), fixing rings I (63) are fixedly connected to ends of the pipes II (61), springs I (64) are fixedly connected between the fixing rings I (63) and the electromagnets I (62), and the fixing rings I (63) are attracted when the electromagnets I (62) are electrified.

7. The short-flow rolling device for a seamless pipe according to claim 6, wherein the spray heads II (29) are slidably connected to an interior of the block I (28), end parts of the spray heads II (29) are fixedly connected to fixing rings II (7), a position of each spray head II (29) at the interior of the block I (28) is correspondingly and fixedly connected to an electromagnet II (71), and springs II (72) are fixedly connected between the fixing rings II (7) and the corresponding electromagnets II (71); and the electromagnets II (71) be capable of attracting the corresponding fixing rings II (7) when being electrified, and each of the spray pipes II is communicated with the interior of the block I (28).

8. The short-flow rolling device for a seamless pipe according to claim 1, wherein the rolling mill comprises:
a conveying roller table (8), two ends of the conveying roller table (8) being mounted with rotary feeding devices (81), and a rolling mill stand (82) being fixedly mounted on the conveying roller table (8); and
rolls (83), three rolls (83) with the same pass being mounted at the rolling mill stand (82), and the three rolls (83) being arranged from top to bottom; a center of the rotary feeding device (81) on a left side being on the same horizontal line as a center of a pass of a lower roller (83), and a center of the rotary feeding device (81) on a right side being on the same horizontal line as a center of a pass of an upper roller (83); and heat treatment boxes (84) being mounted on conveying tracks on two sides of the rolling mill stand (82), a first connecting rod (85) being mounted on a box body of the heat treatment box (84), the first connecting rod (85) being connected to a second connecting rod (86), the first connecting rod (85) and the second connecting rod (86) being capable of driving the rolling mill stand (82) to reciprocate, and the first roller (83) at the top and the third roller (83) at the bottom having a difference of 180° in initial biting positions of the passes.

9. A short-flow rolling method for a seamless pipe by adopting the short-flow rolling device for a seamless pipe according to claim 7, comprising the following steps:
S1: obtaining a seamless pipe after being rolled by a rolling mill, stopping transporting the pipe to keep the pipe still by a transport table (1) when the rolled pipe enters the transport table (1) and one end of the pipe is aligned with a spray ring (23); while driving a rocker I (26) to rotate by a motor I (25) to cause a telescopic rod II (27) to be coincided with an axis of the pipe; and at this time, extending telescopic rods I (22) and the telescopic rod II (27) synchronously, and cooling an outer wall and an inner wall of the pipe by spray heads I (24) and spray heads II (29);
S2: driving the spray ring (23) to perform reciprocating motion on the outer wall of the pipe when the telescopic rods I (22) stretch and retract, with a contact wheel (54) contacting and rotating against a side wall of the transport table (1), driving a ring I (4) to rotate by a face gear (51) through the transmission of a bevel gear I (55), a bevel gear II (57) and a gear I (56), and driving spray heads I (24) to rotate around the pipe by rotating the ring I (4) for rotating water spraying, reducing spraying dead corners and enabling more sufficient and uniform cooling; and
S3: making the telescopic rods I (22) and the telescopic rod II (27) retract to the shortest length after the cooling is completed, driving the rocker I (26) to rotate by the motor I (25), moving the telescopic rod II (27) to a side face of the transport table (1) without affecting the subsequent transportation of the pipe, and transporting the pipe continuously by the transport table (1) for the subsequent processes.
